(19) United States
(12) Patent Application Publication
(10) Pub. No.: US 2009/0073271 A1
(43) Pub. Date: Mar. 19, 2009

(54) Extended look instrument

(76) Inventors: Wesley Grenlund, Puyallup, WA (US); Aaron Grenlund, Puyallup, WA (US); Charles Loomis, Edmonds, WA (US); Robert Kostelecky, Puyallup, WA (US)

Correspondence Address: CHARLES J RUPNICK, PO BOX 46752, SEATTLE, WA, 98146, US

(21) Appl. No.: 12/231,901

(22) Filed: Sep. 5, 2008

Related U.S. Application Data
(63) Continuation of application No. 12/070,383, filed on Feb. 15, 2008, now abandoned.
(60) Provisional application No. 60/901,736, filed on Feb. 16, 2007.

(51) Int. Cl. H04N 5/232

(52) U.S. Cl. 348/211.8; 348/E05.042

(57) ABSTRACT

The present invention is a camera package with a viewing screen, a long flexible arm that will stay in a fixed position once adjusted for remote viewing of areas of automobiles and appliances not otherwise visible by a repairperson or mechanic servicing the device. The camera package includes additional lighting in nonvisible wavelengths for viewing objects otherwise not visible to the human eye. The camera package is capable of hands free operation. This hands free operation allows the technician to make adjustments or work on the problem at hand.

This application claims priority benefit of copending Utility patent application Ser. No. 12/070,383 filed in the names of Aaron Grenlund and Wesley Grenlund on Feb. 15, 2008, the complete disclosure of which is incorporated herein by reference, which claims priority benefit of copending Provisional Patent Application Ser. No. 60/901,736 filed in the names of Aaron Grenlund and Wesley Grenlund on Feb. 16, 2007, the complete disclosure of which is incorporated herein by reference.

### FIELD OF THE INVENTION

The present invention relates generally to a camera, and in particular a remote viewing instrument to view objects in tight places or in areas where visual observation is not possible.

### BACKGROUND OF THE INVENTION

After viewing the restrictions of servicing automotive vehicles it became apparent the need to sometimes see in places not visible by the repairperson or mechanic.

### SUMMARY OF THE INVENTION

After viewing the restrictions of servicing automotive vehicles it became apparent the need to sometimes see in places not visible by the repairperson or mechanic. To solve this problem we have invented a camera package with a viewing screen, a long flexible arm that will stay in a fixed position once adjusted. The camera package comes with additional lighting. The package can be operated hands free. This hands free operation allows the technician to make adjustments or work on the problem at hand. The following description and claims address these needs.

Other aspects of the invention are detailed herein.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1 illustrates a novel remote viewing instrument that is operable as a service tool to be the remote eyes and reduce time to repair today's automobiles and appliances;

FIG. 2 through FIG. 29 illustrate operation of the novel remote viewing instrument according to one embodiment, wherein:

FIG. 2 illustrates initial energizing of the novel remote viewing instrument according to one embodiment wherein manual activation of a ON-OFF power switch energizes a display screen on a base viewing module,

FIG. 3 illustrates one aspect of the settings mode of the novel remote viewing instrument wherein software settings are selectable by the user and are displayed on the display screen,

FIG. 4 illustrates that activation of a camera mode selection function control feature initiates functions of resident software for the real time viewing or “camera” mode of the novel remote viewing instrument and returns the current real time image generated by a video imager to the display screen,

FIG. 5 illustrates that activation of either of two image rotation function control features associated with either of clockwise (shown) or counter-clockwise image rotation initiates functions of resident software for incremental rotation of the image displayed on the display screen,

FIG. 6 illustrates that activation of a choice selector or “select” function control feature initiate the function of resident software for selecting or “capturing” a new current image showing on the display screen, optionally including a new time and date stamp,

FIG. 7 illustrates that activation of a play back function control feature initiates a function of resident software for displaying or playing back previously captured and stored images, optionally including the time and date stamp,

FIG. 8 and FIG. 9 illustrate nominally LEFT and RIGHT function control arrow keys being operated in play back mode as BACKWARD and FORWARD scrolling function control keys to initiate resident software functions for scrolling backward and forward, respectively, through a plurality of previously stored images,

FIG. 10 illustrates a plurality of on-screen text format tabs each defining a menu of different software image action functions associated with different image action “soft” function control feature keys that initiate the different functions of resident software for operating on the real time images as they are generated by video imager and displayed on the display screen, or alternatively on previously captured and stored images,

FIG. 11 illustrates that a zoom function can be utilized for decreasing the displayed size of individual parts on the display screen and providing a more global picture of the current scene imaged in real time by the video imager,

FIG. 12 illustrates that, in the play back mode, activation of the image action function control feature key associated with “delete” of current image screen tab choice initiates a function of resident software for erasing the currently displayed image from memory storage,

FIG. 13 illustrates other image actions that are optionally provided by software resident on novel remote viewing instrument, including by example, that by activation of an image action function control feature key associated with the “more” screen tab choice, an image action associated with one or more image action “soft” function control feature keys may be re-associated with different software functions,

FIG. 14 illustrates that, when operated in listing menu mode, as illustrated in activation of the image action “soft” function control feature key associated with the “zoom” screen tab choice initiates the function of resident software for actively increasing the size of individual thumbnails, while decreasing a quantity of columns and rows displayed.

FIG. 15 illustrates that activation of an image action “soft” function control feature key associated with the “zoom” screen tab choice initiates the function of resident software for, in the alternative, actively decreasing the size of individual thumbnails, while increasing the number of columns and rows displayed,

FIG. 16 illustrates another image action that is optionally provided by software resident on the novel remote viewing instrument, wherein activation of a image action “soft” function control feature key associated with the “more” screen tab choice causes an image action associated with one or more image action “soft” function control feature keys may be re-associated with a software function resident on the novel remote viewing instrument for initiating a function for selecting one or more thumbnails of the list of thumbnails currently displayed on the display screen,

FIG. 17 illustrates that, by activation of an image action “soft” function control feature key associated with the “more” screen tab choice, an image action associated with one or more image action “soft” function control feature keys may be further re-associated with additional different software functions resident on the novel remote viewing instrument, including but not limited to a software “delete” function for deleting the stored image associated with selected thumbnail from storage in on-board memory,

FIG. 18 illustrates operation of the software “select” function for selecting thumbnail and indicating the selection by highlighting,

FIG. 19 illustrates operation of the software “delete all” function for deleting the stored image associated with selected thumbnail and other stored images associated with each of all other currently displayed thumbnails from storage in on-board memory,

FIG. 20 illustrates that activation of an image action “soft” function control feature key associated with software “delete all” function further operates to activate an on-screen confirmation query for confirming the “delete all” action before the function is consummated,

FIG. 21 illustrates a progress indicating sub-function of the software “delete all” function for indicating progress of deleting the stored images from storage in on-board memory,

FIG. 22 illustrates operation of resident software menu function by activation of the function control feature key for on-screen display of a list of software settings selectable by the user,

FIG. 22 illustrates operation of resident software menu function by activation of a function control feature key for on-screen display of a list of software settings selectable by the user, including by example and without limitation, a function of resident software for re-associating the image action “soft” function control feature keys with a resident software function for setting current time and date,

FIG. 23 illustrates that activation of the image action “soft” function control feature key associated with the “time/date” screen tab choice initiates a function of resident software for adjusting current time and date to appropriate settings,

FIG. 24 illustrates that additionally, activation of software for adjusting time and date further initiates resident software back-up function for “exiting” software time and date adjusting function, whereby time and date are displayed on-screen for a short period before the current real time image from the video imager is again displayed,

FIG. 25 illustrates another example wherein another of “soft” function control feature keys is re-associated with a resident software function for formatting a flash memory card coupled to a flash memory port,

FIG. 26 illustrates that activation of an image action “soft” function control feature key associated with software “formatting” function of a flash memory card further operates to activate an on-screen confirmation query for confirming the “format” action before the function is consummated,

FIG. 27 illustrates a progress indicating sub-function of software “format” function for indicating progress of formatting the memory card, including a software back-up function for “exiting” the software “delete all” function when formatting function is completed,

FIG. 28 and FIG. 29 illustrate operation of resident software screen tab toggle function for toggling between display and non-display or hiding on-screen display of plurality of on-screen text format tabs that define the menu of different software image action functions associated with different image action “soft” function control feature keys, wherein FIG. 28 illustrates the normal real time viewing or “camera” mode of the novel remote viewing instrument showing the video output signals from the video imager being displayed on-screen, and FIG. 29 illustrates that activation of a toggle function control feature initiates the function of resident software for displaying or unhiding on-screen text format tabs;

FIG. 30 is a block diagram of an exemplary embodiment of the novel remote viewing instrument, which describes electrical connections to the camera, display, battery, key pad, LED driver, video amplifier, key latch and keypad decoder;

FIG. 31 is a block diagram overview of another exemplary embodiment of the novel remote viewing instrument showing the components and couplings therebetween;

FIG. 32 is a block diagram of an exemplary embodiment of a remote video imaging package of the novel remote viewing instrument;

FIG. 33 is a block diagram of an exemplary embodiment of a control handle, which provides strategic control of components of the novel remote imaging package;

FIG. 34 is a block diagram of an exemplary embodiment of a base viewing module of the novel remote imaging package showing a central System Object Model (SOM) which is an object architecture that provides a full implementation of the Concise Object Relational Architecture (CORBA) standard;

FIG. 35 is an overview level state diagram for software resident on the novel remote viewing instrument showing that outlines the user interface (UI) interaction initiated with the image review or “play back” function, grid navigation function, deleting function and card formatting function;

FIG. 36 is a detailed state diagram of one embodiment of the software functions initiated from the image review function of the novel remote viewing instrument;

FIG. 37 is a detailed state diagram of one embodiment of the software functions initiated from the image review or “play back” function;

FIG. 38 is a detailed state diagram of one embodiment of the software functions initiated from the grid navigation function of the novel remote viewing instrument;

FIG. 39 is a detailed state diagram of one embodiment of the software functions initiated from the deleting function of the novel remote viewing instrument, which includes both of the current image deleting function and delete all function; and

FIG. 40 is a detailed state diagram of one embodiment of the software functions initiated from the card formatting function of the novel remote viewing instrument.

### DETAILED DESCRIPTION OF PREFERRED EMBODIMENT

In the Figures, like numerals indicate like elements.

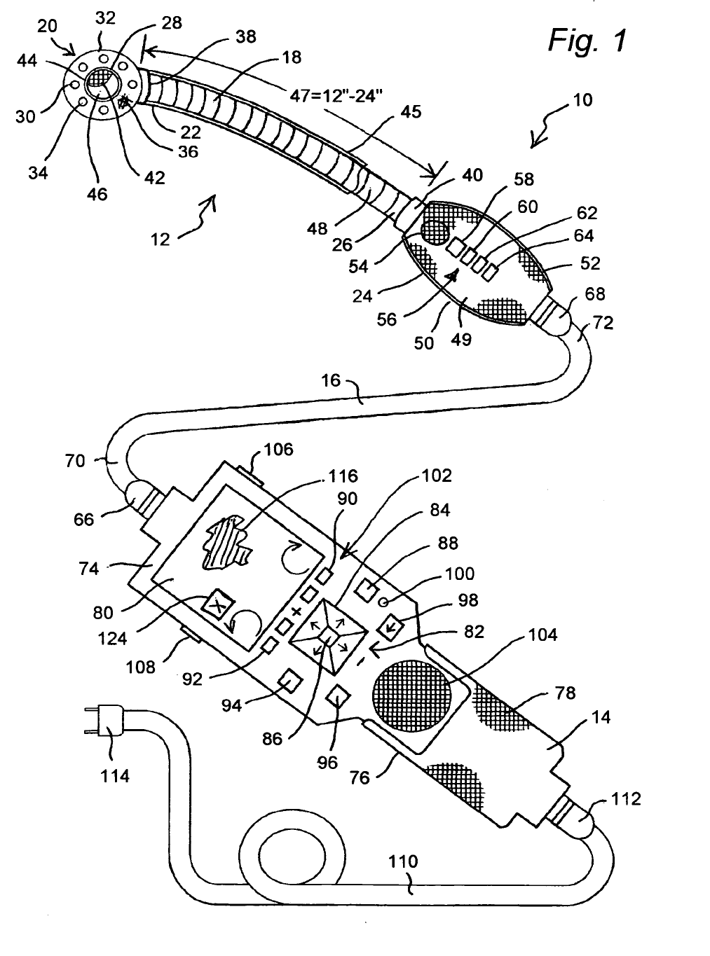

FIG. 1 illustrates a remote viewing instrument 10 that is operable as a service tool to be the remote eyes and reduce time to repair today's automobiles and appliances.

Remote viewing instrument 10 is formed of a handheld probe 12 linked to a base viewing module 14 by a flexible interconnect cable 16. Handheld probe 12 is formed by an articulatable boom 18 coupling a compact and self-contained remote video imaging package 20 adjacent to a distal end 22 thereof to a control handle 24 adjacent to a proximal end 26. Video imaging package 20 includes a video imager 28 and a plurality of illuminators 30 combined in a small robust housing or other enclosure 32. By example and without limitation, enclosure 32 arranges video imager 28 and illuminators 30 substantially perpendicular to boom 18 for side viewing. The plurality of illuminators 30 is arranged in a pattern around video imager 28 for substantially uniform light distribution within a field of view of video imager 28. Alternatively, illuminators 30 are positioned in control handle 24 and a plurality of optical fibers are arranged between illuminators 30 and positions around video imager 28 for projecting illumination into the field of view.

A light sensor 34, such as an Avargo APDS-9002-021 light sensor or similar device, is optionally included as part of video imaging package 20. An optional remote sound pick-up or microphone 36 may be included as part of video imaging package 20 for listening to machinery during operation while viewing the same. Sound pick-up 36 is optionally carried on articulatable boom 18 along with remote imaging package 20, and optionally even in the same enclosure 32 housing all of video imager 28, illuminators 30 and optional light sensor 34, if present.

According to one embodiment, a substantially water-resistant connector 38 is coupled between enclosure 32 and distal end 22 of boom 18. A substantially water-resistant connector 40 is coupled between control handle 24 and proximal end 26 of boom 18.

Optionally, substantially water-resistant rotatable connector 38 between enclosure 32 and distal end 22 of boom 18 is further embodied as a substantially rotatable connector for rotating enclosure 32 up to full circle around boom 18 for viewing in different directions without changing the user's grip on control handle 24. Alternatively, substantially water-resistant connector 40 between control handle 24 and proximal end 26 of boom 18 is further embodied as a substantially rotatable connector for rotating boom 18 up to full circle around control handle 24 for accomplishing the same purpose of viewing in different directions without changing the user's grip on control handle 24.

By example and without limitation, video imager 28 utilizes complementary metal-oxide semiconductor (CMOS) digital camera technology for minimal power consumption and operation in low light levels. For example, video imager 28 includes a charge-coupled device (CCD) sensor 42, i.e. digital camera, that converts received light into electrical signals representing an image within a field of view. Optionally, remote imaging package 20 utilizes a manual or motor-driven lens focusing mechanism 44 of generally well-known design that is capable of focusing a lens 46 relative to CCD sensor 42 for sharp viewing of objects within a limited range of distances.

Electrical signals obtained from CCD sensor 42 are representative of light generated by a target, as well as light reflected from the target. Accordingly, illuminators 30 are arranged in enclosure 32 to illuminate a field of view of video imager 28. One or more of illuminators 30 are, by example and without limitation, T-1 white light emitting diode (LED) light sources. A proprietary LED driver results in uniform current distribution to the array of LED illuminators 30. Optionally, the wavelength of the LED light source illuminators 30 may be modified to view florescence of different solids, such as soil. Frequency response of CCD sensor 42 may be modified with one or more optical filters to correspond to the modified wavelength of the LED light source illuminators 30, which enhances the viewing area of interest as well as the color of the viewed image.

As discussed herein, sound pick-up 36 permits listening to machinery during operation while viewing the same. The audio output signal of sound pick-up 36 is optionally fed to audio filters that isolate the sound band pass filters that display the frequency of the noise on base module 14 of viewing instrument 10. LED light source illuminators 30 are optionally strobed at the noise frequency to make the fault visually stand still in the image visible to video imager 28 and the viewer eyes.

According to one embodiment, the illumination output of one or more illuminators 30 is selected to radiate in the ultraviolet (UV) range. Selection of illumination sources such as UV range LED illuminators 30, video imager 28 can image objects normally invisible to the human eye. In one example, UV range illuminators 30 in video imaging package 20 are used in combination with a substance only visible to UV light frequencies to detect leaks in automobile components. The UV sensitive substance is a chemical additive mixed with lubrication or other fluid operating in the subject component. UV range illuminators 30 cause the UV sensitive substance in the fluids to fluoresce in the UV frequencies, which fluorescence is imaged by video imager 28. Leaks from the motor, radiator, transmission, air conditioning unit or other component are detected by fluorescence of the fluids carrying the additive and are displayed as visible images by the viewing instrument 10.

The UV range illuminators 30 and CCD sensor 42 combination provides a better defined location of the leak and is superior to current state of the art equipment. Light sensor 34 is optionally used in combination with a selected voltage slope and connected to the LED driver control pin, which combination provides automatic control of light level. Optionally, a trimmer across a stable voltage source provides a variable dc voltage which provides a manual control of light intensity. Alternatively, manual control of light intensity is accomplished by means of a manually operated digital potentiometer.

Video imaging package 20 is positioned at distal end 22 of articulatable boom 18 spaced away from control handle 24 by a distance 47 in the range of about 12 inches to 24 inches. Articulatable boom 18 is sufficiently bendable to permit placement of video imaging package 20 in otherwise inaccessible areas inside of an engine compartment of a truck or car, as well as inside such inaccessible areas as engine combustion chambers by snaking through a spark plug or fuel injector port. Controlled articulation of boom 18 in combination with compact and self-contained remote imaging package 20 with its array of illuminators 30 and lens focusing mechanism 44 thus permits viewing interiors of structures on a miniscule size scale that was impossible with prior art remote viewing devices.

Articulatable boom 18 is, by example and without limitation, a flexible conduit of a generally well-known type formed of a coiled plastic or metal strip 48 wound in a spiral over a hollow channel of electrical insulation. Electrical power and signal cables are conveyed through the hollow channel between control handle 24 and enclosure 32 for receiving information and controlling both video imager 28 and individual illuminators 30. Spiral wound metal strip 48 of boom 18 is optionally substantially encased in an optional water-proof sheath 45 making handheld probe 12 substantially water-resistant, as is generally well-known in the art. Articulatable boom 18 is flexible enough for selected positioning of remote imaging package 20, yet is of sufficient stiffness to hold a selected position while supporting the entire load of imaging package 20 at its distal end 22.

Articulatable boom 18 is of hollow construction having a channel between end connectors 38, 40 for carrying electrical power and signal transmission cables between remote imaging package 20 and control handle 24. Optionally, articulatable boom 18 also carries one or more optical transmission paths, such as optical fibers or other light guides, for transmission of illumination from remote illuminators 30 located in control handle 24 to outputs collocated with video imager 28 as part of enclosure 32. Additional optical transmission paths are optionally carried in articulatable boom 18 for optical communication of reflected light from the target to CCD sensor 42 when video imager 28 is alternatively housed in control handle 24.

Control handle 24 is a handheld structure provided for the user to control positioning of articulatable boom 18 and remote imaging package 20 carried at its distal end 22. According to one embodiment, control handle 24 includes an enclosure 49 that is ergonomically designed to fit comfortably in the palm of a user's hand. Although formed of a substantially rigid material, the structure of enclosure 49 is at least partially covered by a cushioned grip 50 formed, for example, of a soft elastomeric material. Cushioned grip 50 also provides slip resistance by means of texturing 52 over all or part of its surface. According to one embodiment, cushioned grip 50 and texturing 52 extend into a slight depression 54 that operates as a thumb rest for improved control of probe 12 and, by extension, control of maneuvering and placement of remote imaging package 20 at distal end 22 of articulatable boom 18.

Control handle 24 includes limited control of components of remote imaging package 20. By example and without limitation, control handle 24 includes a panel 56 of several function control features in the form, for example, of buttons coupled to electrical switches contained in enclosure 49. By example and without limitation, one function control feature 58 is an image capture feature coupled to capture a view currently imaged on CCD sensor 42. Another function control feature 60 is an illumination intensity maximizer for increasing intensity of illumination generated by illuminators 30, while another function control feature 62 is an illumination intensity reducer for reducing intensity of illumination generated by illuminators 30. Thus, intensity of illuminators 30 of remote imaging package 20 are optionally modified to improve viewing conditions, and function control features 60 and 62 provide manual control of such illumination intensity. Alternatively, manual control of illumination intensity is alternatively accomplished using a single function control feature 60 coupled to control a digital potentiometer resident in control handle 24. Still another function control feature 64 is an illumination source selector for selecting between different illuminators 30 for casting illumination of different wavelengths into the field of view. For example, illumination source selector function control feature 64 selects between available light sources, for example, between LED illuminators 30 generating white light, and different LED illuminators 30 that radiate in the ultraviolet (UV) range. Other common functions of remote video imaging package 20 are also contemplated and may be either included as part of panel 56 of function control features or substituted for one or more of the above features without deviating from the scope and intent of the present invention. For example, another optional function control feature is a sound pick-up selector for alternately selecting and deselecting sound pick-up 36. In still another example, another optional function control feature is a focus control feature for driving motor-driven lens focusing mechanism 44 for focusing a lens 46 relative to CCD sensor 42 for sharp viewing of objects within a limited range of distances. Accordingly, these and other optional function control features are also contemplated and may be either included as part of panel 56 of function control features or substituted for one or more of the above features without deviating from the scope and intent of the present invention.

Flexible interconnect cable 16 coupling control handle 24 to base viewing module 14 of remote viewing instrument 10 is constructed in a conventional manner. Flexible interconnect cable 16 includes a plurality of video output signal carrying conductors capable of carrying digital video data generated by video imager 28, as well as conventional electrical signal conductors capable of transporting audio data as well as bi-directional communication of data in digital format, all substantially encased in a water-proof sheath. Flexible interconnect cable 16 is coupled by respective water-resistant connectors 66 and 68 to base viewing module 14 at its proximal end 70 and to control handle 24 at its distal end 72. Flexible interconnect cable 16 is any suitable length that permits convenient operation of probe 12 remotely from base viewing module 14. For example, interconnect cable 16 is in the range of 3 feet to 6 feet in length, whereby control handle 24 of probe 12 can be conveniently gripped by user in one hand, while user grips base viewing module 14 in the other hand. Else, interconnect cable 16 is long enough for base viewing module 14 to be selectively positioned for viewing by the operator. For example, base viewing module 14 is optionally conveniently perched on a tool cart or nearby work bench, while user grips control handle 24 of probe 12 in one hand for manipulating articulatable boom 18 and placing video imaging package 20 for viewing a selected target while keeping the other hand free for other functions, such as self-support, using other tools, or moving interfering obstacles to name a few.

Base viewing module 14 of remote viewing instrument 10 is embodied by an enclosure 74 formed of a substantially rigid material and is optionally at least partially covered by a cushioned jacket 76. Cushioned jacket 76 is formed, for example, of a soft elastomeric material and also provides slip resistance by means of texturing 78 over all or part of its surface.

Remote viewing instrument 10 operates in several different modes, including but not limited to, a live feed of real time viewing or “camera” mode, an image review or “play back” mode, an image edit mode, and a settings mode. Images generated by video imager 28 and information relevant to the different operational modes are displayed on a display screen 80, such as but not limited to a liquid crystal display (LCD) screen, which is provided on an exposed portion of enclosure 74.

Base viewing module 14 optionally includes an electrical circuit that functions as a means for obtaining a copy of the video image captured by the camera package for remote documentation. A buffer stage minimizes the possibility that a video frame grabber may cause loading on the video camera signal. Addition of the buffer stage was accomplished using a wide bandwidth amplifier. However, care was taken to eliminate oscillations using a wide bandwidth amplifier. Alternatively, remote viewing instrument 10 utilizes a digital method of storing the image. For example, the video output signals from video imager 28 are coupled to a digital recorder. The resultant digital recording of the video signals may be subsequently down loaded to a computer for printing a hard copy. This resultant digital recording may be stored on a flash memory card for further investigation and/or later printing.

Base viewing module 14 also includes a control panel 82 of several function control features in the form, for example, of buttons or keys coupled to electrical switches contained in enclosure 74. By example and without limitation, one function control feature 84 is a direction or navigation control feature having UP, DOWN, LEFT and RIGHT directional navigation arrow keys for navigating among stored images and different choices provided in different operational modes.

According to one embodiment, operation of UP and DOWN arrow keys of function control feature 84 increase and decrease, respectively, the image displayed on display screen 80 during operation of viewing instrument 10 in a zoom mode. In a play back mode of remote viewing instrument 10 UP, DOWN, LEFT and RIGHT function control arrow keys 84 optionally operate to pan the displayed image on display screen 80. According to one embodiment, another function control feature 86 is a choice selector or “select” control function that initiates a selection function of software resident on viewing instrument 10 for selecting a current image to capture and store from real time images displayed on display screen 80 when operating in the real time viewing mode, else, for selecting different choices of action when operating in other modes. Another function control feature 88 initiates a real time viewing or “camera” mode of remote viewing instrument 10 for displaying on display screen 80 in real time scenes imaged by video imager 28. Accordingly, the scenes imaged through lens 46 onto CCD sensor 42 of video imager 28 are displayed in real time by remote viewing instrument 10 on display screen 80.

Remote viewing instrument 10 includes means for rotating images received from video imager 28 and displayed on display screen 80. The display rotating means is embodied in either software or one or more electrical circuits. Optionally, the display rotating means is resident on the video display. Remote viewing instrument 10 further includes a pair of other function control features 90 and 92, which may be coupled to either hardware or software switches controlling the display rotating means. During real time remote viewing, the pair of other function control features 90, 92 initiate image rotation functions of software resident on viewing instrument 10 for rotating display of the image on display screen 80. For example, function control feature 90 initiates a clockwise rotation software function that rotates the image clockwise on display screen 80, for example the displayed image is rotated in discrete increments. According to one embodiment, the image rotation function initiated by function control feature 90 rotates the displayed image clockwise in discrete increments of approximately 90 degrees. However, other embodiments include software functions that rotate the image clockwise in different increments between 1 degree and 90 degrees without departing from the spirit and scope of the invention. For example, software function optionally rotate the image clockwise in increments of 15 degree or 45 degrees without departing from the spirit and scope of the invention. According to one embodiment, repeated operation of function control feature 90 repeatedly rotates the displayed image in the clockwise direction by the same discrete increments for a full rotation around display screen 80.

Function control feature 92 initiates a counter-clockwise rotation software function that rotates the image counter-clockwise on display screen 80, for example the displayed image is rotated counter-clockwise in discrete increments. According to one embodiment, the counter-clockwise image rotation function initiated by function control feature 92 operates as substantial mirror image of the clockwise rotation software function initiated by function control feature 90, such that the counter-clockwise image rotation function rotates the displayed image counter-clockwise in discrete increments of approximately 90 degrees. However, other embodiments include software functions that rotate the image counter-clockwise in different increments between 1 degree and 90 degrees without departing from the spirit and scope of the invention. For example, software function optionally rotate the image counter-clockwise in increments of 15 degree or 45 degrees without departing from the spirit and scope of the invention. According to one embodiment, repeated operation of function control feature 92 repeatedly rotates the displayed image in the counter-clockwise direction by the same discrete increments for a full rotation around display screen 80.

Operation of choice select function control feature 86 at any time during real time remote viewing initiate a function of software resident on viewing instrument 10 that captures and stores the current view imaged by video imager 28. Additionally, according to one embodiment, the

Another function control feature 94 initiates a resident software play back function that plays back previously captured and stored images and permits performance of different operations on the stored images. For example, play back mode permits incremental rotation and subsequent restorage of previously stored images according to the display rotation software function. Play back mode may also operate as a gateway to the image edit mode.

Optionally, according to one embodiment, in play back mode, LEFT and RIGHT function control arrow keys 84 optionally operate as BACKWARD and FORWARD scrolling function control keys to initiate resident software functions for scrolling backward and forward, respectively, through a plurality of previously stored images.

Function control feature 96 initiates a resident software menu function for displaying on display screen 80 a list of software settings selectable by the user. Another function control feature 98 initiates a resident software back-up function that returns to display of a previous screen when viewing instrument 10 is operated in the selectable software settings mode.

When viewing instrument 10 is operated an edit mode, another function control feature 100 initiates a resident software toggle function that alternately displays and hides screen tabs visibly displayed on display screen 80. The screen tabs describe software action functions that are associated with different ones of function control features 102 that initiate different resident action selection software functions associated with action selection keys 102, as discussed herein. Action selection keys 102 are commonly referred to as “soft” keys because their function changes as a function of the current operating mode of viewing instrument 10.

Additionally, enclosure 74 of base viewing module 14 optionally includes a remote audio output device or speaker 104 that is connected to receive the audio output signal of optional remote sound pick-up 36, if present, for listening in real time by the operator to sounds that may be detected. The audio output signal associated with detected sounds is optionally digitally recorded for later play back or down load, even if speaker 104 is not resident on viewing instrument 10 for listening in real time. For example, the audio output signals from sound pick-up 36, if present, are coupled to a digital recorder. The resultant digital recording of the audio signals may be subsequently down loaded to a computer for a hard copy. This digital recording may be stored on a flash memory card for further investigation and/or later printing.

Remote viewing instrument 10 optionally includes a flash memory card port 106, for example of Universal Serial Bus (USB) port type connecting a flash memory card. Else, port 106 of remote viewing instrument 10 optionally is a specific type of flash memory port such as a Secure Digital Memory (SD) Card port that is structured for receiving and communicating with a SD flash memory card of a type that provides data storage for digital cameras. Alternatively, port 106 is utilized for connecting the video output signal of video imager 28 to an external monitor. This video output connection to an external monitor is a useful tool in teaching; the instructor can view the area of interest and explain to the students the point of interest that video imager 28 is focused on.

Remote viewing instrument 10 optionally includes a manual ON-OFF power switch 108. Electrical power is supplied, for example, by battery such as a rechargeable nickel-metal hydride (NiMH) battery or lithium-ion (Li-Ion) battery. A step up voltage converter converts battery voltage to the voltage requirements of the display and camera functions of viewing instrument 10. The battery converter provides a continuous instrument run time of several hours. A power cord 110 is provided for charging the battery from an external source, such as a standard wall outlet. Power cord 110 is coupled to base viewing module 14 by a substantially water-resistant connector 112, but utilizes a conventional plug 114 for connecting to a standard wall outlet.

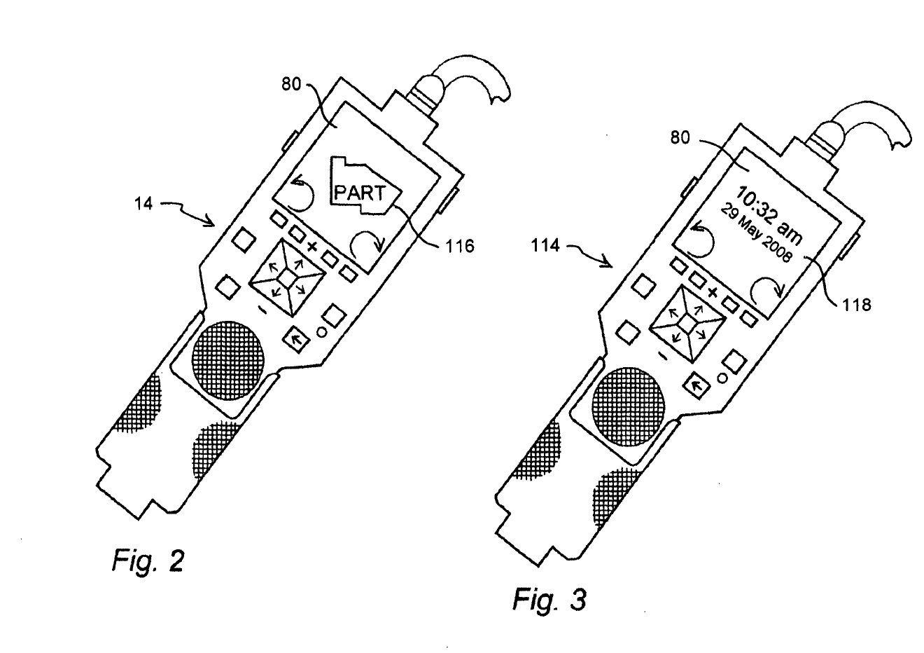

FIG. 2 through FIG. 29 illustrate operation of remote viewing instrument 10 according to one embodiment.

FIG. 2 illustrates initial energizing of remote viewing instrument 10 according to one embodiment wherein manual activation of ON-OFF power switch 108 energizes display screen 80 on base viewing module 14. Real time viewing or “camera” mode is default mode upon boot up of remote viewing instrument 10. Accordingly, a current real time image 116 generated by video imager 28 is displayed.

FIG. 3 illustrates one aspect of the settings mode of remote viewing instrument 10 wherein software settings are selectable by the user. Here, time and date 118 are displayed on display screen 80.

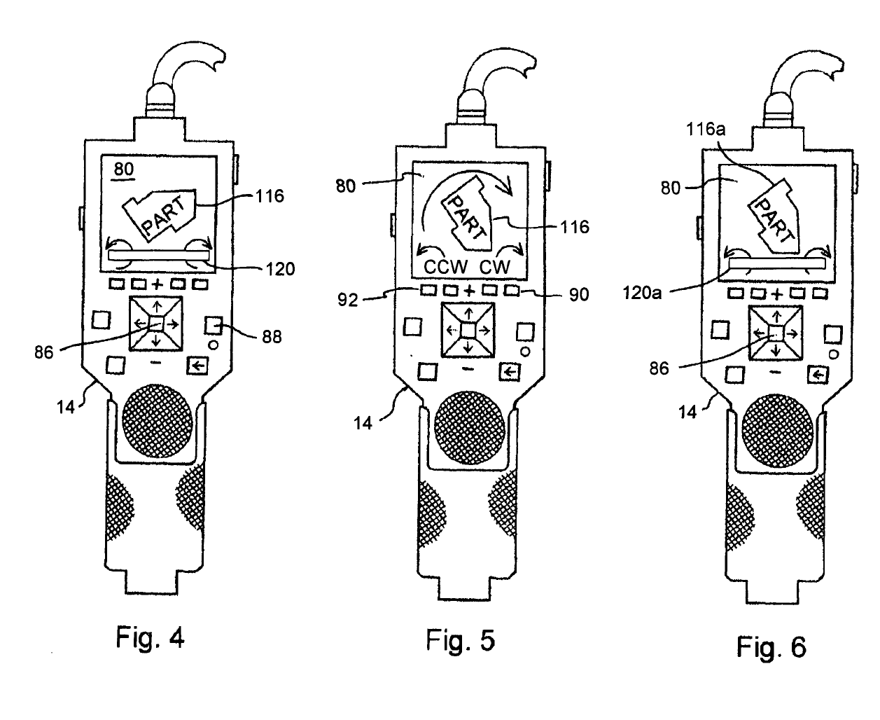

FIG. 4 illustrates that activation of camera mode selection function control feature 88 initiates functions of resident software for the real time viewing or “camera” mode of remote viewing instrument 10 and returns the current real time image generated by video imager 28 to display screen 80.

Activation of choice selector or “select” function control feature 86 initiate the function of resident software for selecting or “capturing” the current image 116 showing on display screen 80. According to one embodiment, the select software function also captures a time and date stamp 120.

FIG. 5 illustrates that activation of either image rotation function control features 90, 92 associated with either of clockwise (shown) or counter-clockwise image rotation initiates functions of resident software for incremental rotation of the image displayed on display screen 80. Here, the discrete increment of rotation illustrated is approximately 90 degrees. However, as discussed herein, other embodiments include software functions that rotate the image clockwise in different increments without departing from the spirit and scope of the invention.

FIG. 6 illustrates that activation of choice selector or “select” function control feature 86 initiate the function of resident software for selecting or “capturing” a new current image 116a showing on display screen 80. According to one embodiment, the select software function also captures a new time and date stamp 120a.

According to one embodiment, captured image 116a is displayed on display screen 80 for a short period, for example about 1 second, then current real time image 116a generated by video imager 28 is again displayed.

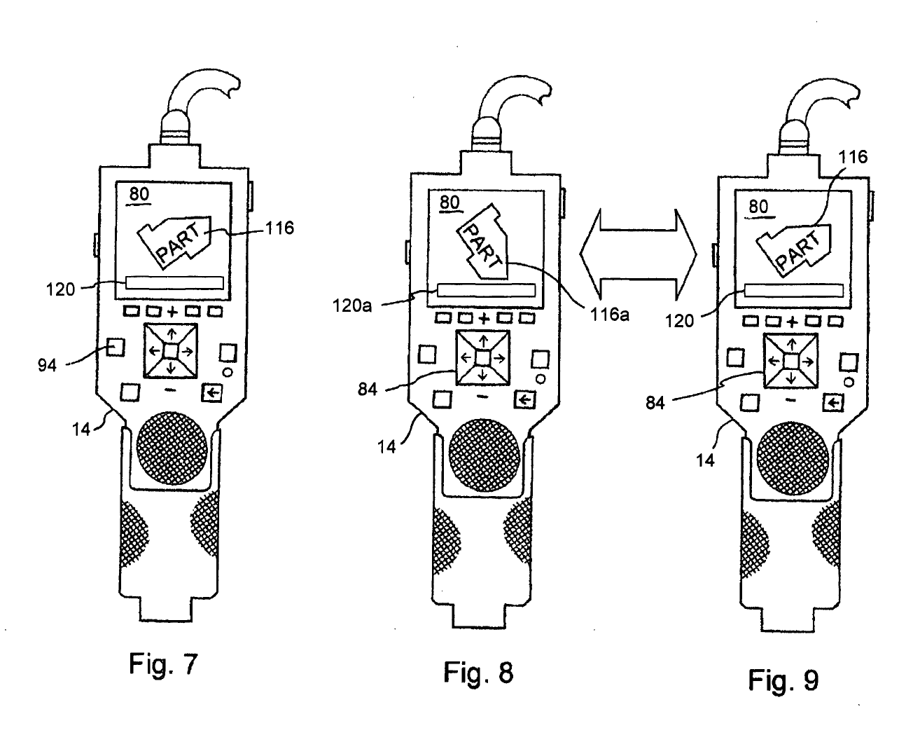

FIG. 7 illustrates that activation of play back function control feature 94 initiates the function of resident software for displaying or playing back previously captured and stored images. For example, play back function control feature 94 is activated to initiate the function for displaying previously captured and stored image 116 having time and date stamp 120.

FIG. 8 and FIG. 9 illustrate nominally LEFT and RIGHT function control arrow keys 84 being operated in play back mode as BACKWARD and FORWARD scrolling function control keys to initiate resident software functions for scrolling backward and forward, respectively, through a plurality of previously stored images 116 and 116a.

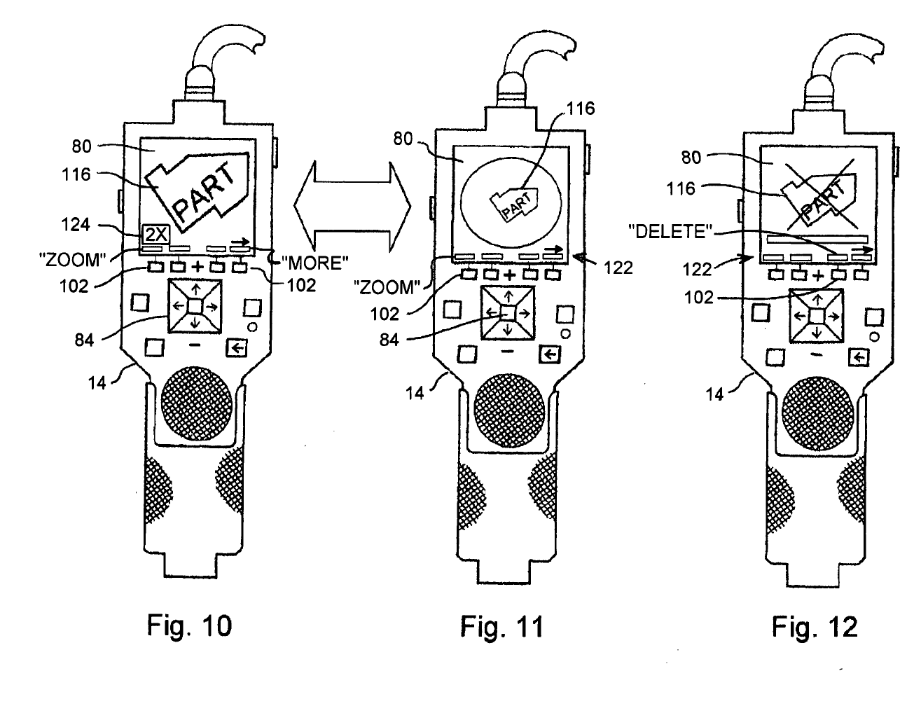

FIG. 10 illustrates a plurality of on-screen text format tabs 122 each defining a menu of different software image action functions associated with different image action “soft” function control feature keys 102 that initiate the different functions of resident software for operating on the real time images as they are generated by video imager 28 and displayed on display screen 80, or alternatively on previously captured and stored images. For example, when viewing instrument 10 is operated in the real time viewing or “camera” mode, activation of image action “soft” function control feature key 102 associated with the “zoom” choice indicated on display screen 80 initiates the function of resident software for actively zooming lens 46 in or out relative to CCD sensor 42 for increasing (shown) the size of a particular feature in a current scene imaged in real time by video imager 28. According to one embodiment, in zoom mode operation of UP and DOWN arrow keys of function control feature keys 84 function as zoom control function control keys to initiate resident software functions for incrementally increasing and decreasing, respectively, the image displayed on display screen 80, as indicated by “+” and “−” symbols, respectively. According to one embodiment, operation of zoom control function control keys 84 for alternately increasing and decreasing the image displayed on display screen 80 also initiates a resident software function for displaying on display screen 80 a text box 124 indicating a current degree of zoom.

Else, as illustrated in FIG. 11, the zoom function can be utilized for decreasing the displayed size of individual parts on display screen 80 and providing a more global picture of the current scene imaged in real time by video imager 28.

Activation of one or more different function controls on base viewing module 14 is effective for initiating a software control function for returning the zoom to normal viewing. For example, activation of either nominally RIGHT function control arrow key 84 or “camera” function control feature 88 re-initiates real time viewing or “camera” mode of remote viewing instrument 10 for displaying on display screen 80 in real time scenes imaged by video imager 28.

Alternatively, when viewing instrument 10 is operated in the real time viewing or “camera” mode, activation of image action “soft” function control feature key 102 associated with the “rotate” choice indicated on display screen 80 initiate the function of resident software for rotating images received from video imager 28 and displayed on display screen 80, as discussed herein. Optionally, other functions of resident software are available and may be associated with different ones of the image action “soft” function control feature keys 102. As indicated by image action “soft” function control feature key 102 associated with the “more” choice indicated on display screen 80, operation of the associated image action “soft” function control feature key 102 may initiate a function of resident software for re-associating the image action “soft” function control feature keys 102 with different image action software functions also resident on viewing instrument 10 and operable in the real time viewing or “camera” mode. For example, a “pan” software function is optionally resident on viewing instrument 10. Activation of image action “soft” function control feature key 102 associated with the “pan” choice indicated on display screen 80 initiates a function of resident software for panning the displayed image on display screen 80. By example and without limitation, UP, DOWN, LEFT and RIGHT function control arrow keys 84 optionally initiate, respectively, functions of software resident on viewing instrument 10 for panning the displayed image 116 up or down, left or right, as indicated by arrows.

When viewing instrument 10 is operated in the play back mode, the above “zoom,” “rotate” and “pan” functions are available, as discussed above. Additional image action functions of software resident on viewing instrument 10 may also be available. For example, as indicated in FIG. 12, in the play back mode activation of image action “soft” function control feature key 102 associated with “delete” current image screen tab choice 122 indicated on display screen 80 initiates a function of resident software for erasing the currently displayed image 116 from memory storage. According to one embodiment, initiation of “delete” current image screen tab choice 122 optionally further initiates a further operates to activate an on-screen confirmation query 125 for confirming the “delete” current image action before the function is consummated. On-screen confirmation query 125 for confirming the “delete” current image action before the function is consummated is substantially the same as on-screen confirmation query 136 for confirming the “delete all” action before the function is consummated, as discussed herein below.

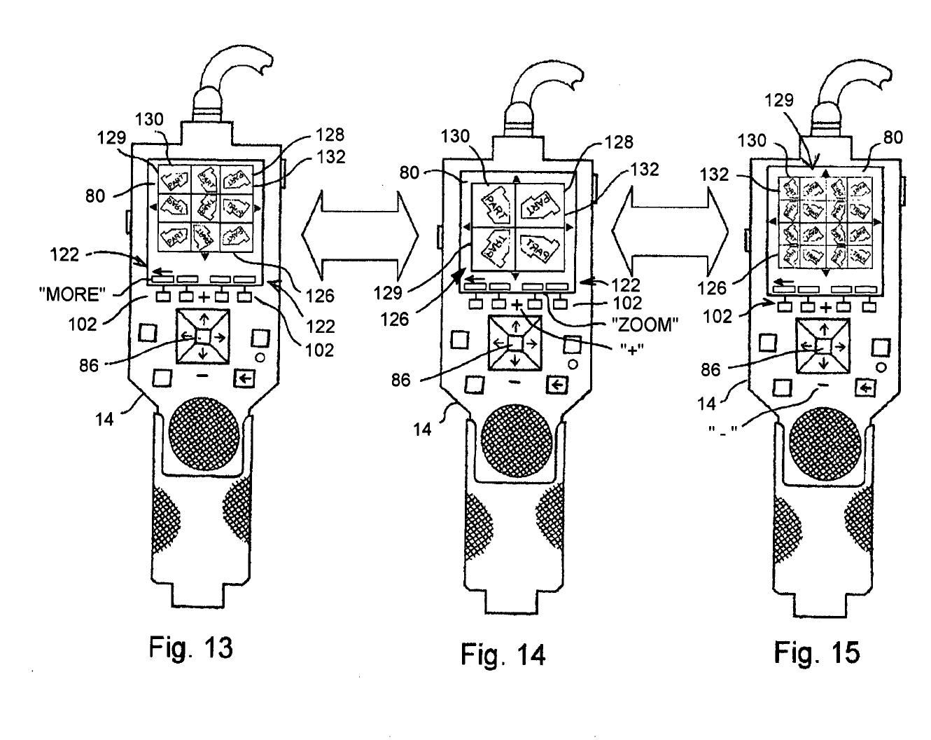

FIG. 13 illustrates other image actions that are optionally provided by software resident on viewing instrument 10. For example, by activation of image action “soft” function control feature key 102 associated with the “more” screen tab choice 122 indicated on display screen 80, an image action associated with one or more image action “soft” function control feature keys 102 may be re-associated with different software functions. By example and without limitation, image action “soft” function control feature keys 102 may be re-associated with image action function software resident on viewing instrument 10 for initiating a function for displaying a menu 126 of different previously captured and stored images that may be selected for play back. By example and without limitation, menu 126 may be displayed on display screen 80 as a listing of previously captured and stored images. The resident software optionally displays listing menu 126 in any convenient format, including but not limited to, a grid (shown) of thumbnails. However, other embodiments include software functions that display listing menu 126 in different formats, including but not limited to, icons, simple lists, and detailed lists, are generally well-known in the art, without departing from the spirit and scope of the invention.

The grid size of listing menu 126 is optionally increased or decreased as a function of software resident on viewing instrument 10. For example, activation of activation of image action “soft” function control feature key 102 associated with the “grid” screen tab choice 122 indicated on display screen 80 initiates the function of resident software for listing all previously captured and stored images as grid of thumbnails. If a large quantity of previously captured images are stored in on-board memory, grid listing menu 126 is optionally limited to a predetermined number of thumbnails 128 per displayed “page” 129, and additional pages are accessed by activation of UP, DOWN, LEFT and RIGHT function control arrow keys 84 which are re-associated by grid listing menu software to either pan grid listing menu 126 by column 130 and row 132, else to scroll up, down, backward and forward, respectively, through different pages of different thumbnails 128 of stored images. Additionally, when operated in listing menu mode, as illustrated in FIG. 14, activation of image action “soft” function control feature key 102 associated with the “zoom” screen tab choice 122 indicated on display screen 80 initiates the function of resident software for actively increasing the size of individual thumbnails 128, while decreasing the quantity of columns 130 and rows 132 displayed.

FIG. 15 illustrates activation of image action “soft” function control feature key 102 associated with the “zoom” screen tab choice 122 indicated on display screen 80 initiates the function of resident software for, in the alternative, actively decreasing the size of individual thumbnails 128, while increasing the number of columns 130 and rows 132 displayed.

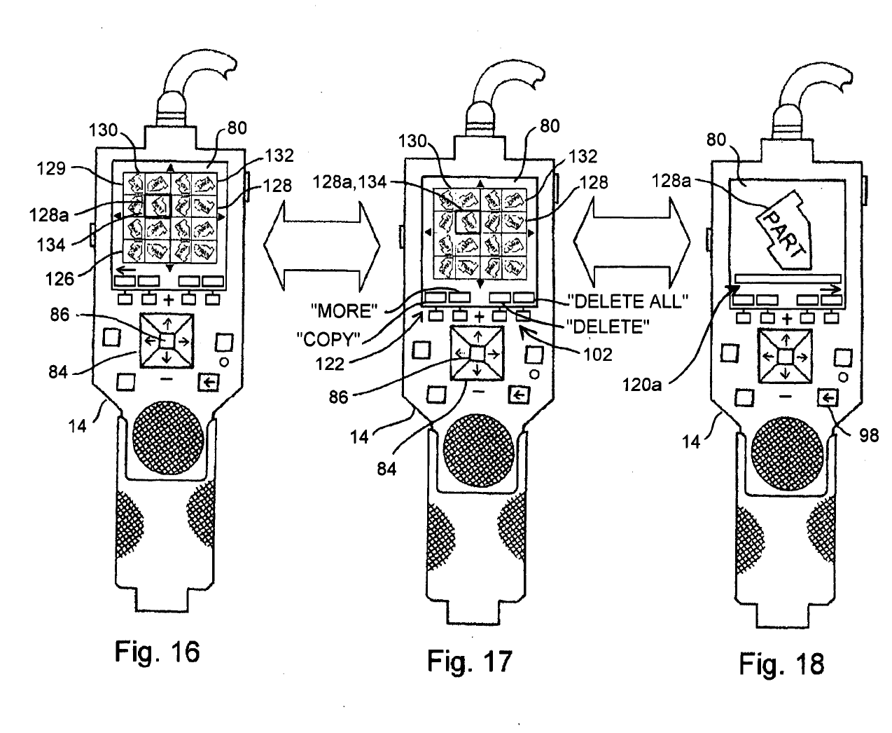

FIG. 16 illustrates another image action that is optionally provided by software resident on viewing instrument 10. Here, by activation of image action “soft” function control feature key 102 associated with the “more” screen tab choice 122 indicated on display screen 80, an image action associated with one or more image action “soft” function control feature keys 102 may be re-associated with a software function resident on viewing instrument 10 for initiating a function for selecting one or more thumbnails 128a of the list of thumbnails 128 currently displayed on display screen 80. For example, thumbnail selecting software initiated by activation of image action “soft” function control feature keys 102 re-associated with thumbnail selection further re-associates UP, DOWN, LEFT and RIGHT function control arrow keys 84 with grid listing menu 126 for navigating or “stepping” through displayed columns 130 and rows 132 of thumbnails 128 until a desired individual thumbnail 128a is encountered. Indication of the currently selected thumbnail 128a is provided by highlighting 134, which is indicated here by a box of heavy lines around currently selected thumbnail 128a. However, other embodiments include software functions that display currently selected thumbnail 128a in different formats, including but not limited to, increased versus decreased image brightness, black-and-white versus color images, and color overlays, are generally well-known in the art, without departing from the spirit and scope of the invention.

FIG. 17 illustrates that, by activation of image action “soft” function control feature key 102 associated with the “more” screen tab choice 122 indicated on display screen 80, an image action associated with one or more image action “soft” function control feature keys 102 may be further re-associated with additional different software functions resident on viewing instrument 10, including a software “delete” function for deleting the stored image associated with selected thumbnail 128a from storage in on-board memory. Other additional different software functions resident on viewing instrument 10 may be alternately associated with image action “soft” function control feature keys 102. For example, one image action “soft” function control feature key 102 may be further re-associated with a screen tab choice 122 associated with a software “copy” function for copying selected thumbnail 128a from one location in storage in on-board memory to another location, or to flash memory card coupled to USB port 106. In another example, another image action “soft” function control feature key 102 may be further re-associated with a screen tab choice 122 associated with a software “export” function for exporting selected thumbnail 128a in a selected format, such as but not limited to, a portable document format (.pdf) file, a tagged image file (.tif), a Joint Photographic Experts Group (.jpg) file, a bitmap (.bmp) file, a graphic interchange format (.gif) file, a small web file (.swf), or other suitable file format.

Another image action “soft” function control feature key 102 may be further re-associated with a screen tab choice 122 associated with a software “delete all” function for deleting the stored image associated with selected thumbnail 128a and other stored images associated with each of all other currently displayed thumbnails 128 from storage in on-board memory.

Activation of choice selector or “select” function control feature key 86 initiates the software “select” function for selecting thumbnail 128a indicated by highlighting 134.

FIG. 18 illustrates operation of the software “select” function for selecting thumbnail 128a indicated by highlighting 134. Here, selection of thumbnail 128a by activation of selection function control feature key 86 further initiates the function of resident software for displaying on display screen 80 previously captured and stored image 116a associated with highlighted and selected thumbnail 128a. Alternatively, activation of selection function control feature key 86 enlarges highlighted and selected thumbnail 128a on display screen 80. In this play back mode of viewing instrument 10, activation of back-up function control feature 98 initiates resident software back-up function for “exiting” display of selected thumbnail 128a and returning screen display 80 to previous screen showing grid listing menu 126 of columns 130 and rows 132 of thumbnails 128. Optionally, previously selected thumbnail 128a is displayed as being indicated by highlighting 134.

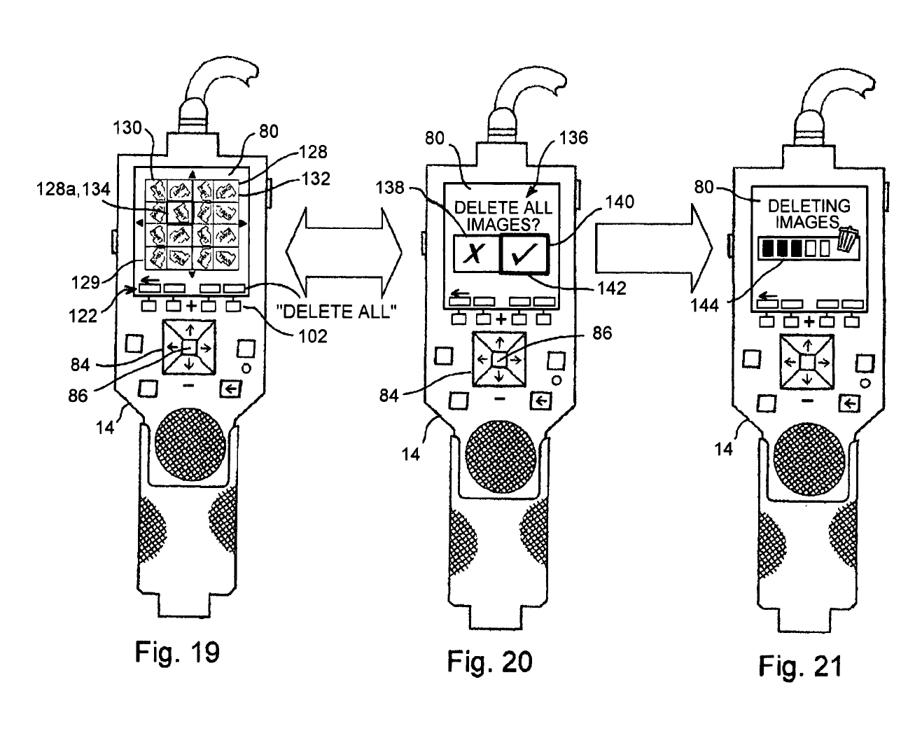

FIG. 19 illustrates operation of the software “delete all” function for deleting the stored image associated with selected thumbnail 128a and other stored images associated with each of all other currently displayed thumbnails 128 from storage in on-board memory.

FIG. 20 illustrates that activation of image action “soft” function control feature key 102 associated with software “delete all” function further operates to activate an on-screen confirmation query 136 for confirming the “delete all” action before the function is consummated. By example and without limitation, activation of image action “soft” function control feature key 102 associated with software “delete all” function further operates to re-associate nominally LEFT and RIGHT function control arrow keys 84 with “deny” and “confirm” responses 138 and 140 indicated by “X” (left) and check (right) on-screen choices. Accordingly, activation of LEFT function control arrow key 84 optionally indicates “deny” response 138 by highlighting 142 and denies operation of software “delete all” function. Additionally, activation of LEFT “deny” function control arrow key 84 further initiates resident software back-up function for “exiting” software “delete all” function.

Else, activation of RIGHT function control arrow key 84 indicates “confirm” response 140 by highlighting 142 (shown) and confirms operation of software “delete all” function for deleting the stored image associated with selected thumbnail 128a and other stored images associated with each of all other currently displayed thumbnails 128 from storage in on-board memory.

FIG. 21 illustrates a progress indicating sub-function of software “delete all” function for indicating progress of deleting the stored images from storage in on-board memory. By example and without limitation, the software progress indicating sub-function causes display of a progress meter 144 on display 80 indicative of progress of deleting image files. Activation of RIGHT “confirm” function control arrow key 84 further initiates resident software back-up function for “exiting” software “delete all” function when deleting function is completed.

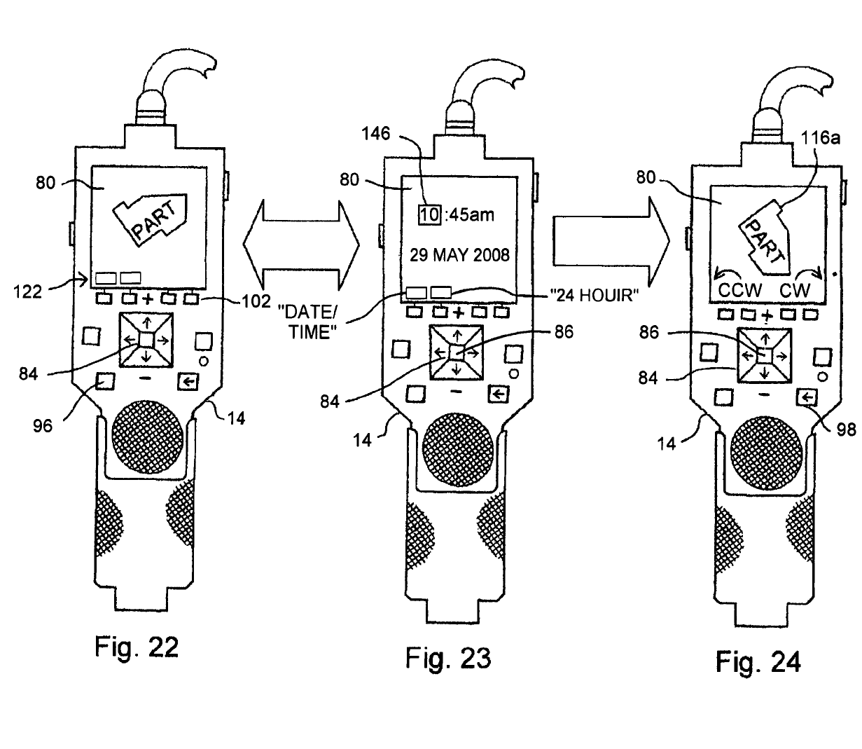

FIG. 22 illustrates operation of resident software menu function by activation of function control feature key 96 for displaying on display screen 80 a list of software settings selectable by the user. Here, by example and without limitation, activation of settings function control feature key 96 initiates a function of resident software for re-associating the image action “soft” function control feature keys 102 with different setting selections associated with different ones of the on-screen text format tabs 122. For example, one of “soft” function control feature keys 102 is re-associated with a resident software function for setting current time and date. According to one embodiment, the time and date setting function is available while viewing instrument 10 is operated in the real time viewing or “camera” mode.

FIG. 23 illustrates that activation of image action “soft” function control feature key 102 associated with the “time/date” screen tab choice 122 indicated on display screen 80 initiates a function of resident software for adjusting current time and date to appropriate settings. Activation of time and date adjusting software further operates to re-associate UP, DOWN, LEFT and RIGHT function control arrow keys 84 to time and date adjusting function for scrolling or “stepping” through the hour, minute, am/pm, day, month and year sectors, as well as adjusting the values of same. For example, LEFT and RIGHT function control arrow keys 84 scroll or “step” between the different hour, minute, am/pm, day, month and year sectors, while UP and DOWN function control arrow keys 84 increase and decrease, respectively, the values for a current sector which is indicated by highlighting 146.

According to one embodiment, activation of the software for adjusting time and date includes a sub-function that permits activating or deactivating a 24-hour clock format to replace a conventional 12-hour clock format. The 24-hour clock format associates another one of “soft” function control feature keys 102 with another screen tab choice 122 indicated on display screen 80 for selecting or deselecting the 24-hour clock format.

FIG. 24 illustrates that additionally, activation of software for adjusting time and date further initiates resident software back-up function for “exiting” software time and date adjusting function. For example, according to one embodiment, time and date are displayed on display screen 80 for a short period, for example about 2-3 seconds, then current real time image 116a generated by video imager 28 is again displayed. Alternatively, activation of back-up function control feature 98 initiates resident software back-up function for “exiting” display of time and date adjusting function.

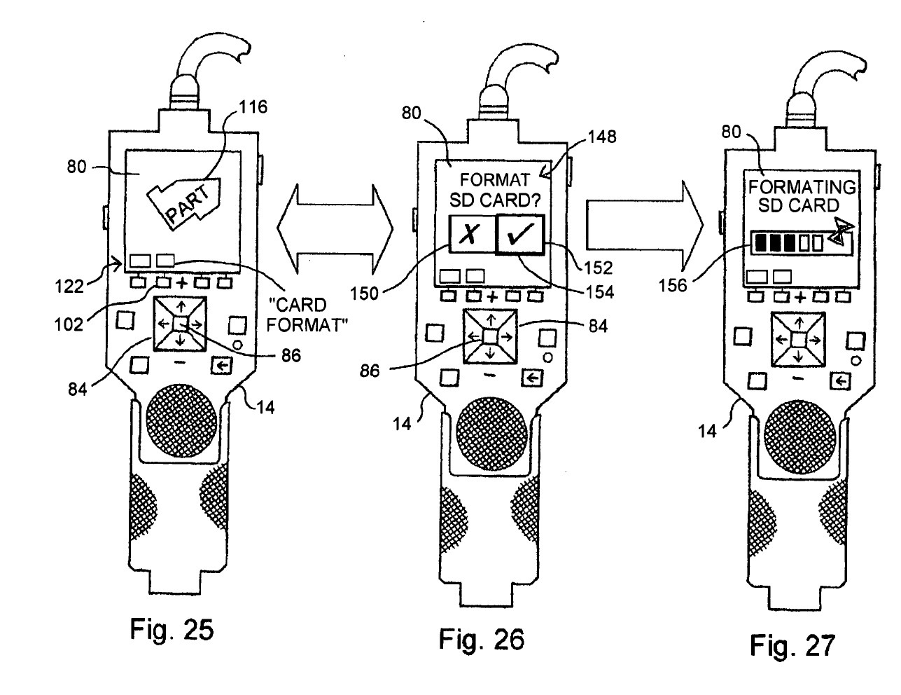

FIG. 25 illustrates another example wherein another of “soft” function control feature keys 102 is re-associated with a resident software function for formatting a flash memory card coupled to flash memory port 106.

FIG. 26 illustrates that activation of image action “soft” function control feature key 102 associated with software “formatting” function of a flash memory card further operates to activate an on-screen confirmation query 148 for confirming the “format” action before the function is consummated. By example and without limitation, activation of image action “soft” function control feature key 102 associated with software “format” function further operates to re-associate nominally LEFT and RIGHT function control arrow keys 84 with “deny” and “confirm” responses 150 and 152 indicated by “X” (left) and check (right) on-screen choices. Accordingly, activation by select function control feature key 86 of LEFT function control arrow key 84 optionally indicates “deny” response 150 by highlighting 154 and denies operation of software “format” function. Additionally, activation by select key 86 of LEFT “deny” function control arrow key 84 further initiates resident software back-up function for “exiting” software “format” function.

Else, activation of RIGHT function control arrow key 84 indicates “confirm” response 140 by highlighting 154 (shown) and confirms operation of software “format” function for formatting of a flash memory card coupled to port 106.

FIG. 27 illustrates a progress indicating sub-function of software “format” function for indicating progress of formatting the memory card. By example and without limitation, the software progress indicating sub-function causes display of a progress meter 156 on display 80 indicative of progress of formatting the flash memory card. Activation of RIGHT “confirm” function control arrow key 84 further initiates resident software back-up function for “exiting” software “delete all” function when formatting function is completed.

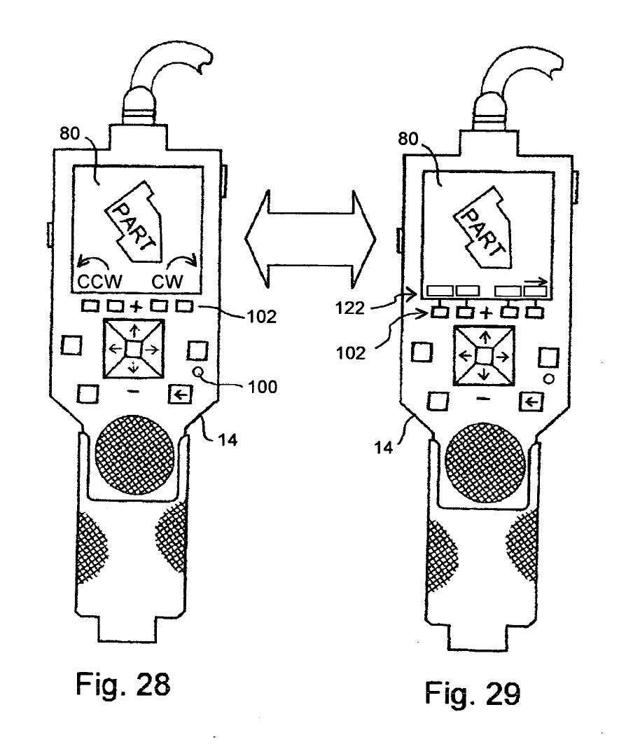

FIG. 28 and FIG. 29 illustrate operation of resident software screen tab toggle function for toggling between display and non-display or hiding on screen display 80 of plurality of on-screen text format tabs 122 that define the menu of different software image action functions associated with different image action “soft” function control feature keys 102.

FIG. 28 illustrates the normal real time viewing or “camera” mode of remote viewing instrument 10 showing the video output signals from video imager 28 being displayed on screen display 80. When viewing instrument 10 is operated in the real time viewing or “camera” mode, activation of toggle function control feature key 100 activates associated toggle function for toggling between ON and OFF on-screen text format tabs 122. Accordingly, FIG. 29 illustrates activation of toggle function control feature 98 initiates the function of resident software for displaying or unhiding on-screen text format tabs 122. Alternatively, operation of any one of action selection “soft” keys 102 initiates the function of resident software for displaying or unhiding on-screen text format tabs 122. Thereafter, toggle function control feature 98 is activated to toggle OFF on-screen text format tabs 122.

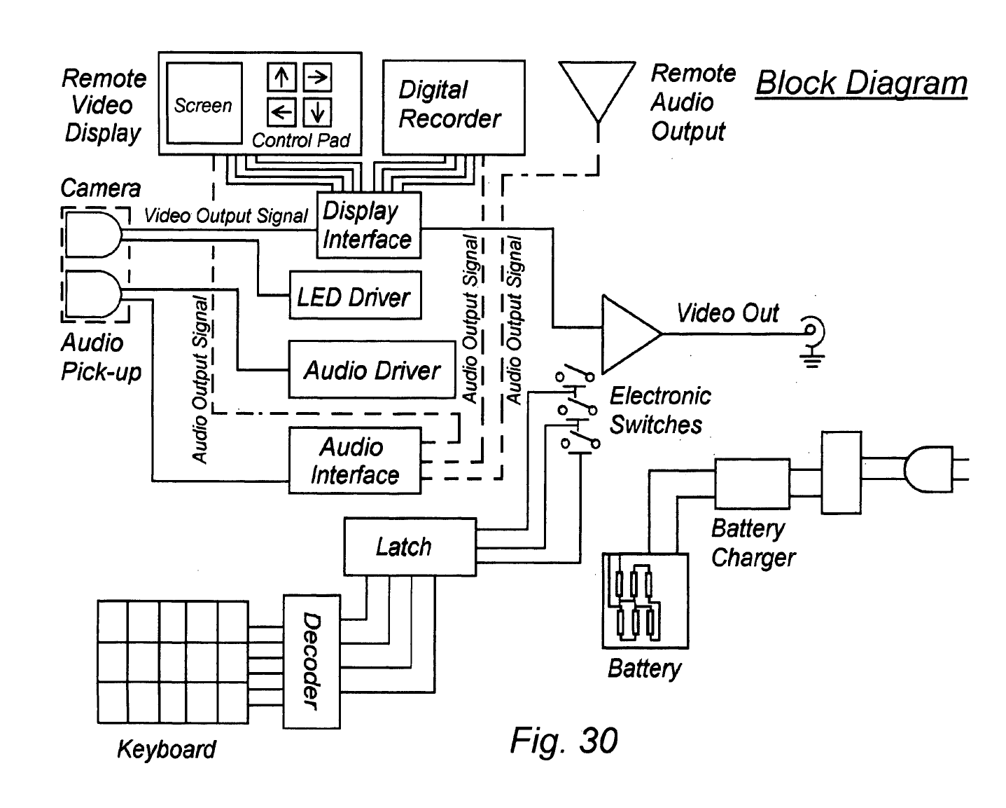

FIG. 30 is a block diagram of an exemplary embodiment of remote viewing instrument 10, which describes electrical connections to the camera, display, battery, key pad, LED driver, video amplifier, key latch and keypad decoder.

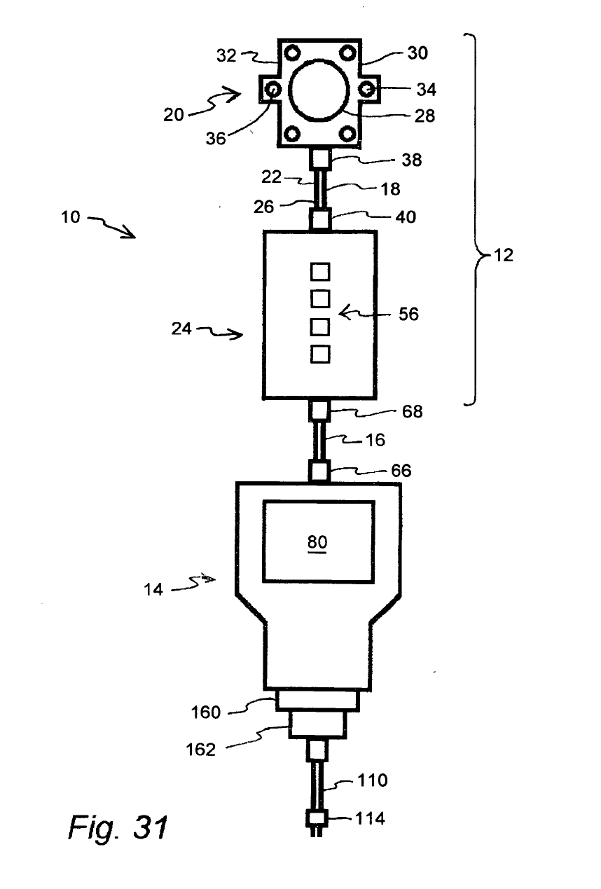

FIG. 31 is a block diagram overview of another exemplary embodiment of remote viewing instrument 10. Handheld probe 12 is shown as including remote video imaging package 20 is coupled adjacent to distal end 22 of articulatable boom 18 by optionally rotatable connector 38, and further including control handle 24 coupled adjacent to proximal end 26 of articulatable boom 18 by optionally rotatable connector 40. Here, self-contained remote video imaging package 20 is illustrated as including video imager 28 and plurality of both white and UV range LED illuminators 30, as well as optional light sensor 34, if present, and optional sound pick-up or microphone 36, if present, in same enclosure 32. Remote viewing instrument 10 is also illustrated here as including base viewing module 14 being coupled to control handle 24 of handheld probe 12 by flexible interconnect cable 16 with respective water-resistant connectors 66 and 68. Remote viewing instrument 10 is further illustrated here as including optionally rechargeable battery 160 coupled into base viewing module 14. For example, battery 160 is coupled into base viewing module 14 using substantially water-resistant technology of a type that is generally well-known in the art.

When battery 160 is optionally embodied rechargeable battery, an optional battery charger 162 is coupleable thereto for recharging rechargeable battery 160. Battery charger 162 connectable by power cord 110 to a standard wall outlet.

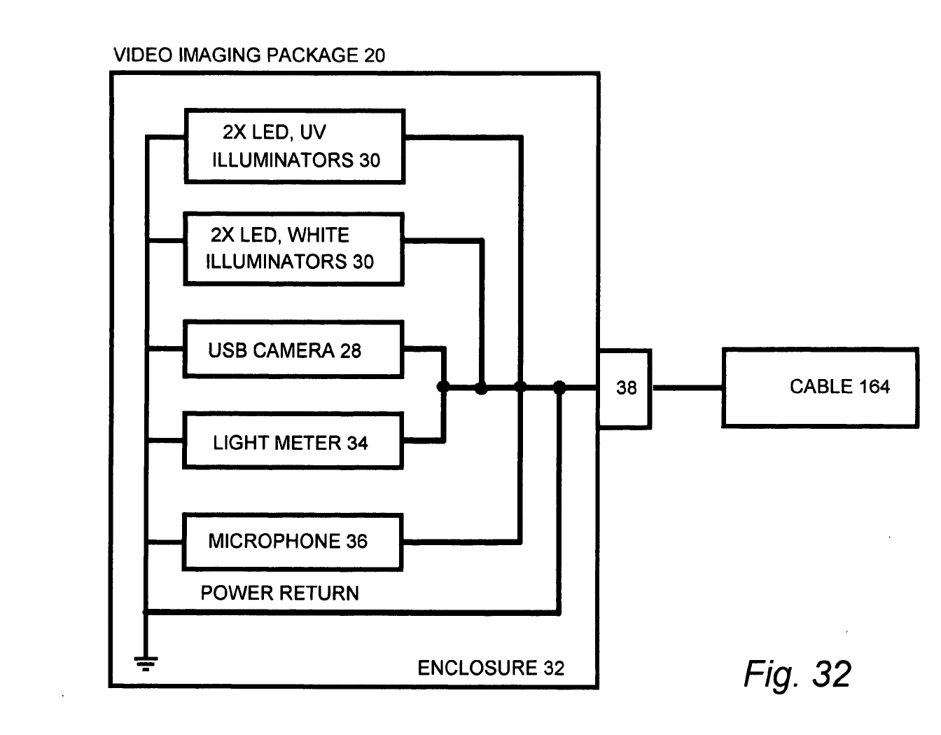

FIG. 32 is a block diagram of an exemplary embodiment of remote video imaging package 20 of remote viewing instrument 10. Remote video imaging package 20 portion of handheld probe 12 includes video imager 28 and plurality of both white and UV range LED illuminators 30, as well as optional light sensor 34, if present, and optional sound pick-up or microphone 36 all in same enclosure 32 and coupled into connector 38. Connector 38 is coupled to flexible interconnect cable 164 having a plurality of video output signal carrying conductors capable of carrying digital video data generated by video imager 28, as well as conventional electrical signal conductors capable of transporting audio data output signal from sound pick-up or microphone 36, as well as bi-directional communication of data in digital format, all substantially encased in a water-proof sheath. Flexible interconnect cable 164 is carried in the hollow channel of articulatable boom 18 to control handle 24, which is coupled through connector 40 to the proximal end 26 thereof.

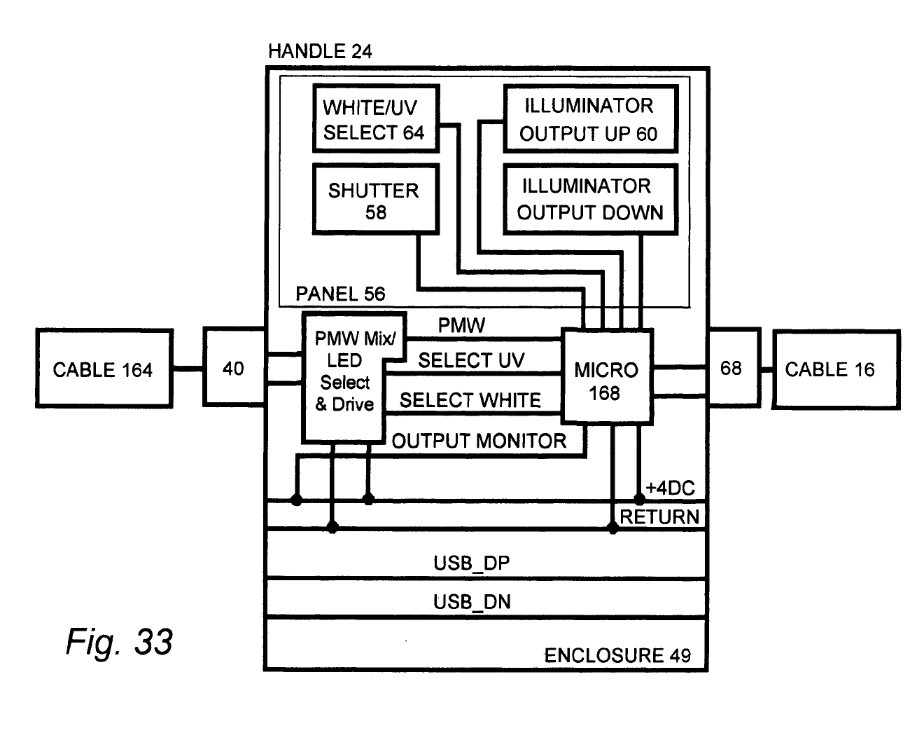

FIG. 33 is a block diagram of an exemplary embodiment of control handle 24, which provides strategic control of components of remote imaging package 20. Control handle 24 includes image capture feature function control feature key 58 coupled to capture a view currently imaged on CCD sensor 42, illumination source selector function control feature key 64 coupled to select between available light sources of white light and different UV range LED illuminators 30, illumination intensity maximizer function control feature key 60 for increasing intensity of illumination generated by illuminators 30, and illumination intensity reducer function control feature key 62 for reducing intensity of illumination generated by illuminators 30. All feature control function keys of panel 56 are coupled to an on-board microprocessor 168 for interpreting instructions from feature control function keys of panel 56, controlling operations of video imager 28 for capturing images and the operations of the different white and UV range illuminators 30. Microprocessor 168 may also be coupled to control motor-driven lens focusing mechanism 44 for autofocus of focusing lens 46, as well as being coupled to receive inputs of controlling light sensor 34 for controlling light levels output by illuminators 30.

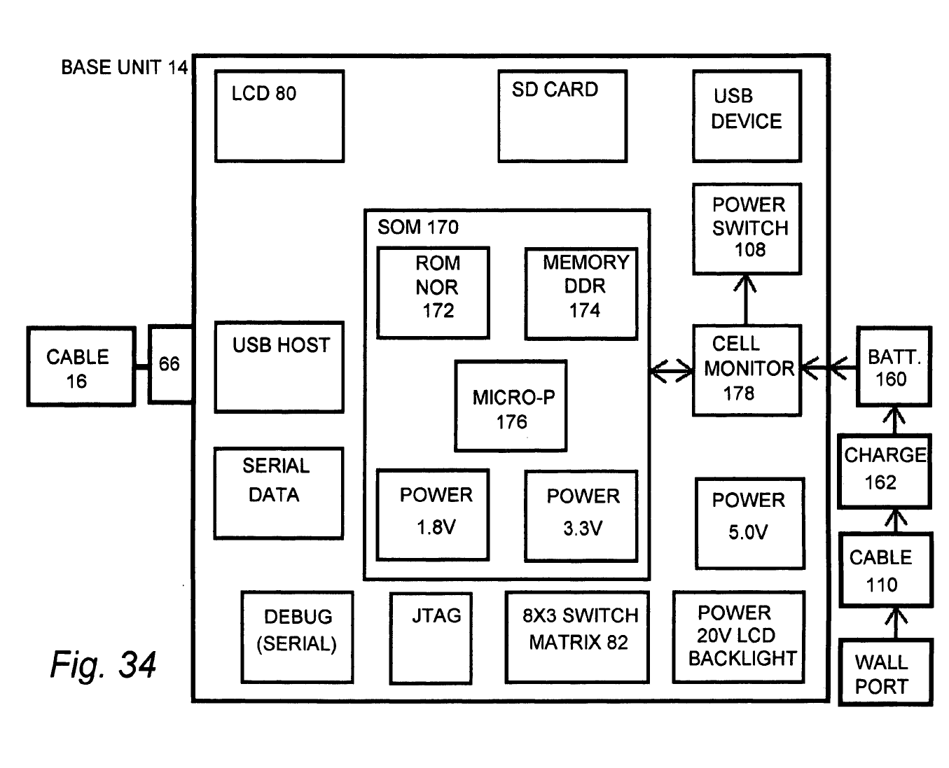

FIG. 34 is a block diagram of an exemplary embodiment of base viewing module 14 showing a central System Object Model (SOM) 170 which is an object architecture that provides a full implementation of the Concise Object Relational Architecture (CORBA) standard. SOM 170 is language independent and is supported by a variety of large compiler and application development vendors. SOM 170 includes both Read-Only Memory (ROM) 172 with Not-Or (NOR) electronic logic gate and Double Data Rate (DDR) random access memory (RAM) 174 coupled to microprocessor 176. Control panel 82 of function control features is provided, by example and without limitation, as a eight-by-three switch matrix. A cell monitor and power latching module 178 is coupled to receive power from optionally rechargeable battery 160. When battery 160 is rechargeable, as shown, suitable battery charger 162 is supplied between power cord 110 and battery 160. Cell monitor and power latching module 178 is coupled to ON-OFF power switch 108. As discussed herein, base viewing module 14 is coupled by water-resistant connector 66 to flexible interconnect cable 16, and there to control handle 24.

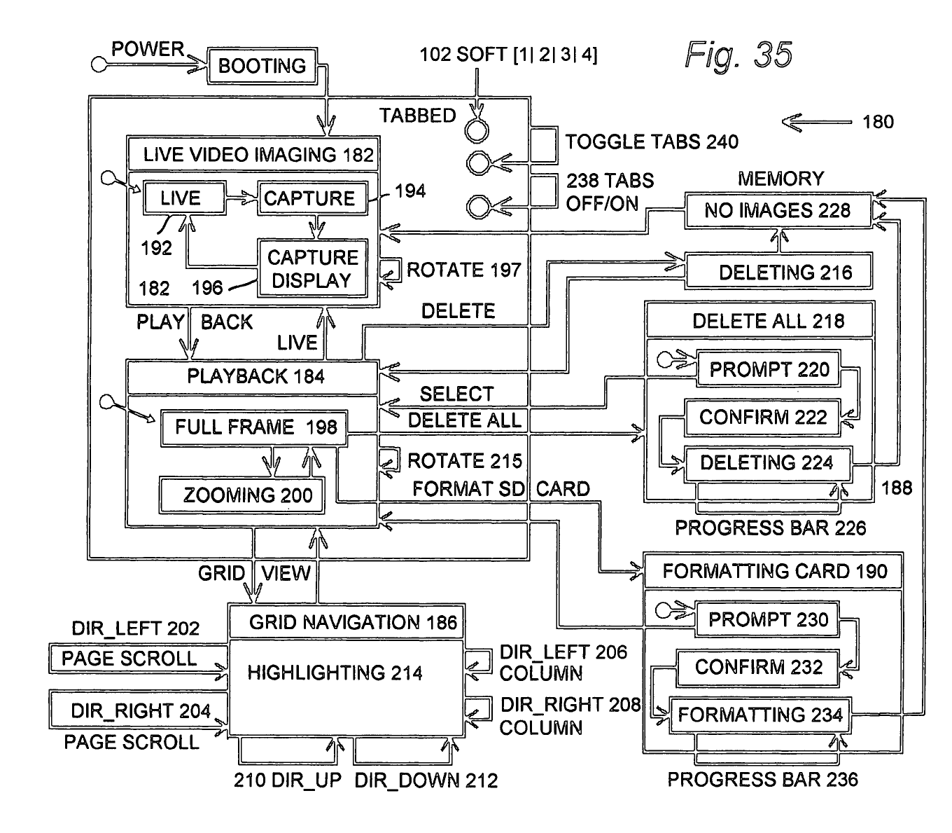

FIG. 35 is an overview level state diagram 180 for software resident on remote viewing instrument 10 showing that outlines the user interface (UI) interaction initiated with image review or “play back” function 184, grid navigation function 186, deleting function 188 and card formatting function 190. Live or real time video imaging function 182 is substantially a standard digital camera user interface (UI). Live or real time video imaging function 182 includes both a function 192 for operating live or real time video imaging, and an image capture function 194. Live or real time video imaging function 182 initiates real time viewing or “camera” mode of remote viewing instrument 10 for displaying on display screen 80 in real time scenes imaged by video imager 28. Image capture function 194 feeds into a capture display function 196 whereby captured image 116a is displayed on display screen 80 for a short period, for example about 1 second, then capture display function 196 feeds into live or real time video imaging function 192 for displaying current real time image 116a generated by video imager 28 is again displayed. Live or real time video imaging function 182 also includes a function 197 for initiating clockwise and counterclockwise rotation of the current real time image 116 generated by video imager 28 as displayed on screen display 80.

Live or real time video imaging function 182 couples into image review function 184 to access and initiate both a function 198 for full frame display of the live or real time image, and a function 200 for zooming on the displayed live image.

Live or real time video imaging function 182 couples into image review or “play back” function 184, which initiates play back of previously captured and stored images and permits performance of different operations on the stored images.

Image review function 184 includes both a function 198 for full frame image display, and a function 200 for zooming on the currently displayed image. Image review or “play back” function 184 couples into grid navigation function 186, which permits browsing of previously captured images that are stored in on-board memory. Grid navigation function 186 initiates display of stored images in a grid of thumbnails, as illustrated herein, or another convenient format, as discussed herein. When grid navigation function 186 displays stored images in a grid of thumbnails, one sub-function 202 initiates left direction scrolling of pages 129, while another sub-function 204 initiates right direction scrolling of pages 129. Another sub-function 206 initiates left direction scrolling of columns 130, while another sub-function 208 initiates right direction scrolling of columns 130. Yet other sub-functions 210 and 212 initiate up and down direction scrolling, respectively, of rows 132. Grid navigation function 186 also includes a sub-function 214 for indication of the currently selected thumbnail 128a, for example, by initiating highlighting 134.

Image review function 184 couples back into live or real time video imaging function 182 for quick toggling between on-screen display of previously captured and stored images and live feed of images currently generated by video imager 28.

Image review function 184 also a function 215 for initiating clockwise and counterclockwise rotation of the currently selected image 128a as displayed on screen display 80. Selected image deleting function 188 and delete all function 190 are initiated from image review function 184. By example and without limitation, according to one embodiment card formatting function 190 is also initiated from image review function 184.

Deleting function 188 further includes both a function 216 that causes deletion of the currently selected image 128a, and another function 218 that causes deletion of all the images 128 currently stored in memory. Current image deleting function 216 further optionally includes a sub-function for performing on-screen confirmation query 125 for confirming the “delete” current image action before the function is consummated generally as described herein for delete all function 218. For example, current image deleting function 216 includes a prompt sub-function that is initiated when the delete command is entered, a confirm sub-function that is initiated from the prompt sub-function, and a delete sub-function that accomplishes deletion of currently selected image 128a from memory. Current image deleting function 216 also optionally includes a progress bar sub-function that is initiated as a function of a positive response to the confirm query and initiates an on-screen illustration of progress of the deleting function.

Delete all function 218 includes a sub-function for performing on-screen confirmation query 136 for confirming the “delete all” images currently stored in memory action before the function is consummated, including prompt sub-function 220 that is initiated when the delete all command is entered, a confirm sub-function 222 that is initiated from the prompt sub-function, and a delete sub-function 224 that accomplishes deletion of all images 128 currently stored in memory. Delete all function 218 optionally includes a progress bar sub-function 226 that is initiated as a function of a positive response to the confirm query and initiates an on-screen illustration of progress of the deleting function. Delete all function 218 optionally also includes a sub-function 228 for initiating an on-screen display indicating that no previously stored images are currently present in memory.

Card formatting function 190 further includes a sub-function for performing on-screen confirmation query 148 for confirming the “format” action before the function is consummated, including prompt sub-function 230 that is initiated when the formatting command is entered, a confirm sub-function 232 that is initiated from the prompt sub-function, and a format sub-function 234 that accomplishes formatting of SD or other memory card. Card formatting function 190 optionally includes a progress bar sub-function 236 that is initiated as a function of a positive response to the confirm query and initiates an on-screen illustration of progress of the formatting function.

Soft keys 102, four shown by example and without limitation, associated with one or more of above functions are coupled by software sub-functions to initiate the various actions, as discussed herein. Soft keys 102 are further coupled to initiate software sub-function 238 for initiating on-screen display of a plurality of on-screen text format tabs 122 defining a menu of different software image action functions associated with different image action “soft” function control feature keys 102. Function control feature 100 initiates software toggle function 240 that alternately initiates visible display and hiding of on-screen tabs on display screen 80.

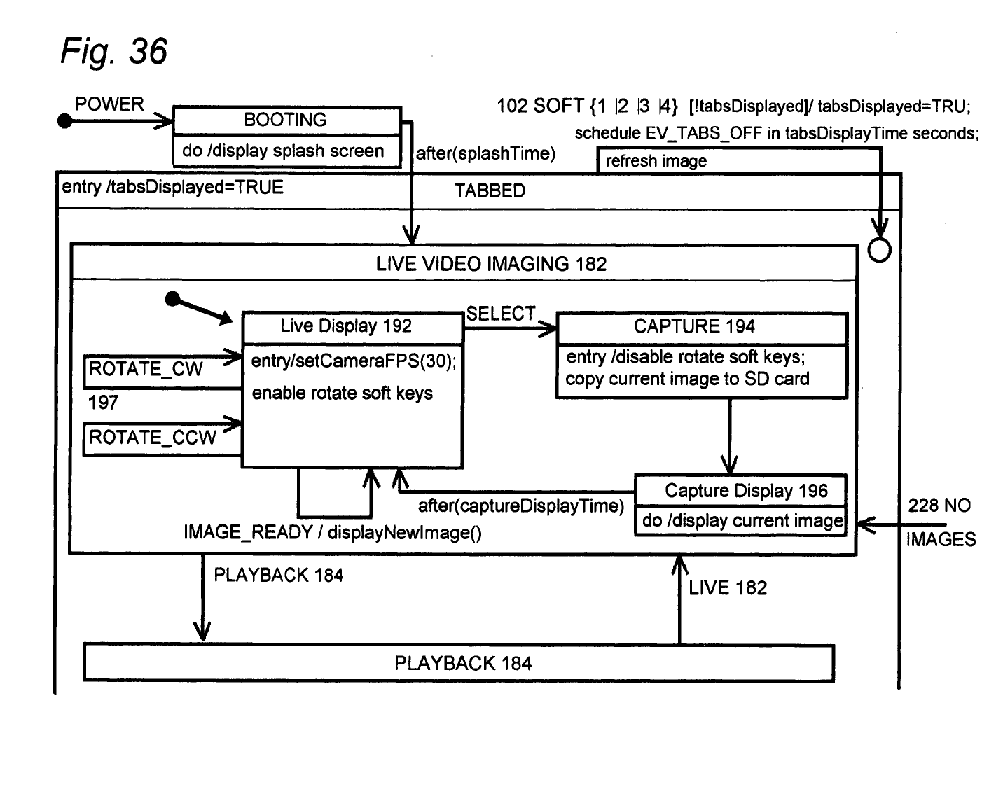

FIG. 36 is a detailed state diagram of one embodiment of the software functions initiated from image review function 184.

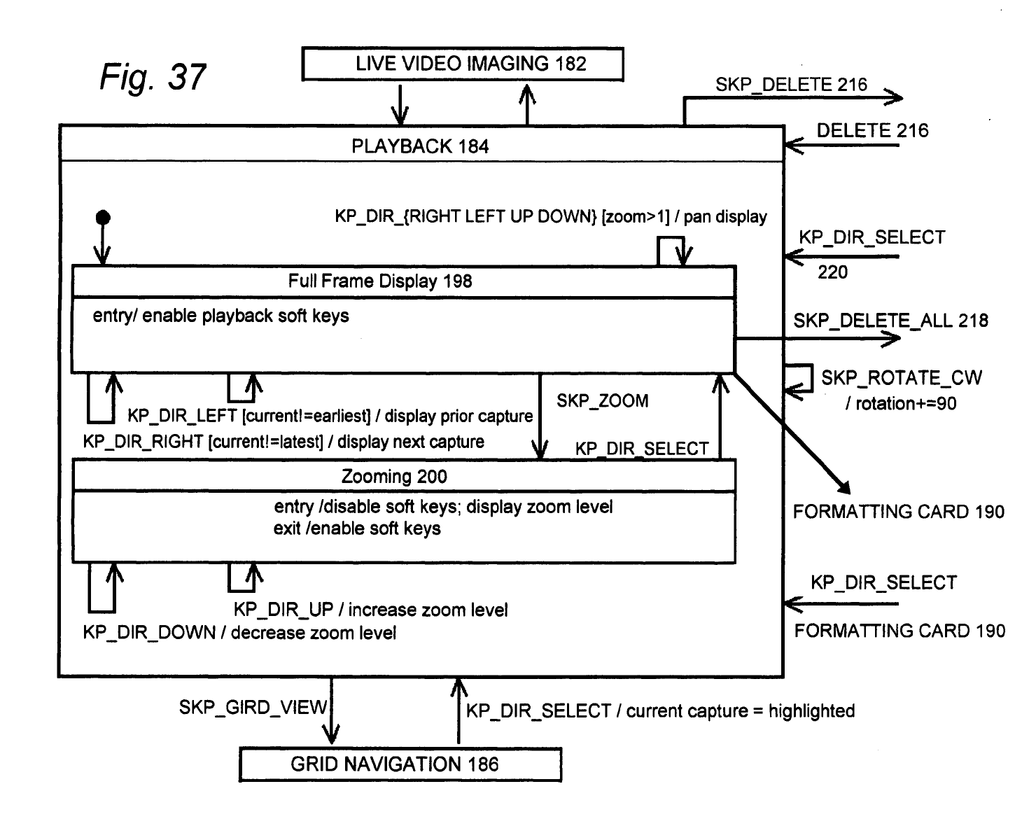

FIG. 37 is a detailed state diagram of one embodiment of the software functions initiated from image review or “play back” function 184.

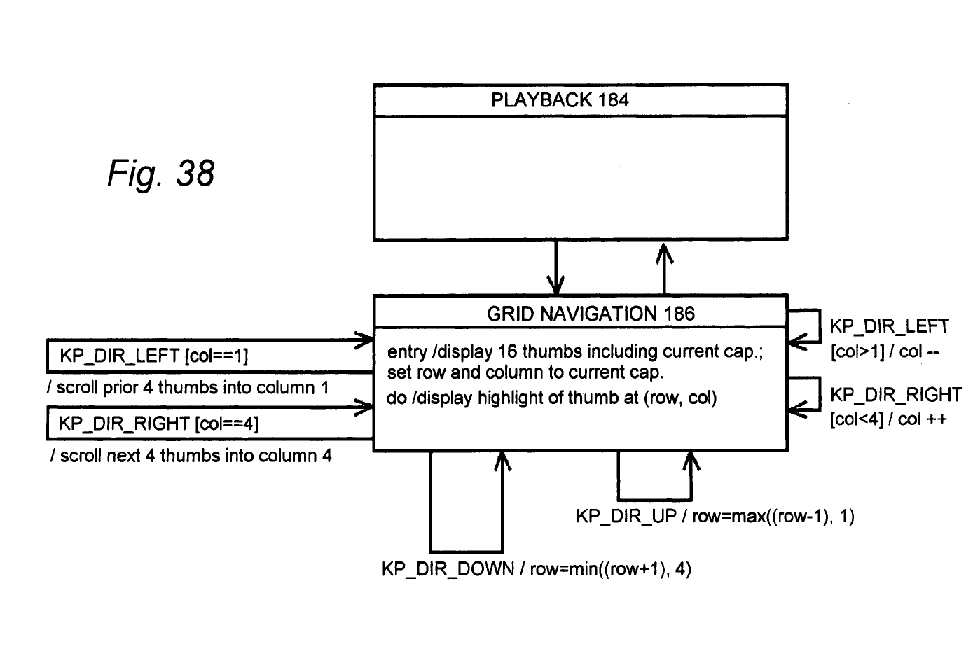

FIG. 38 is a detailed state diagram of one embodiment of the software functions initiated from grid navigation function 186.

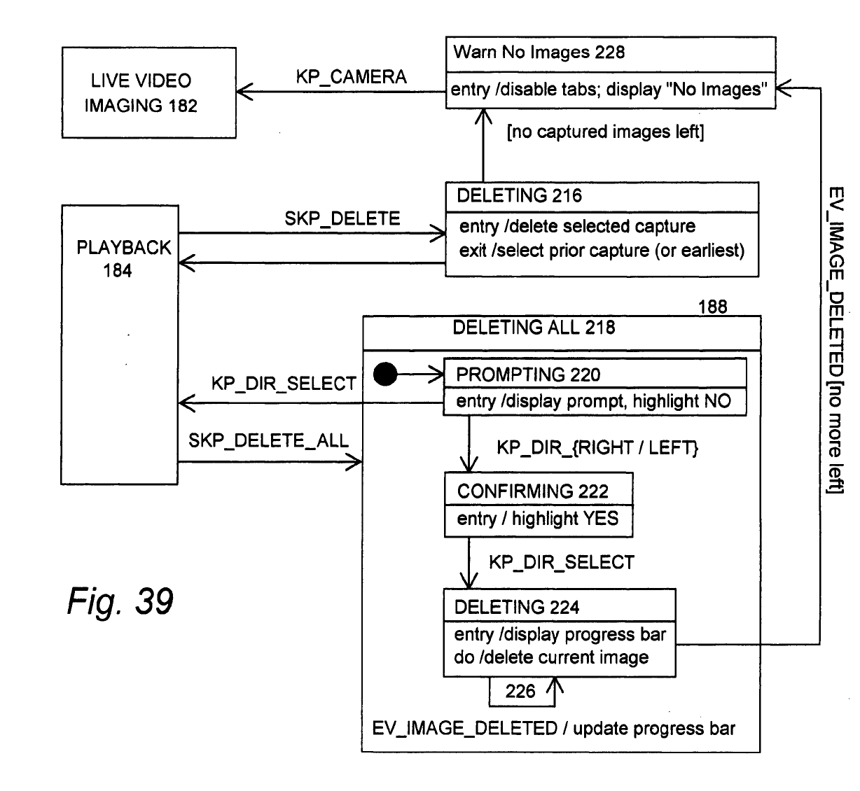

FIG. 39 is a detailed state diagram of one embodiment of the software functions initiated from deleting function 188, which includes both current image deleting function 216 and delete all function 218.

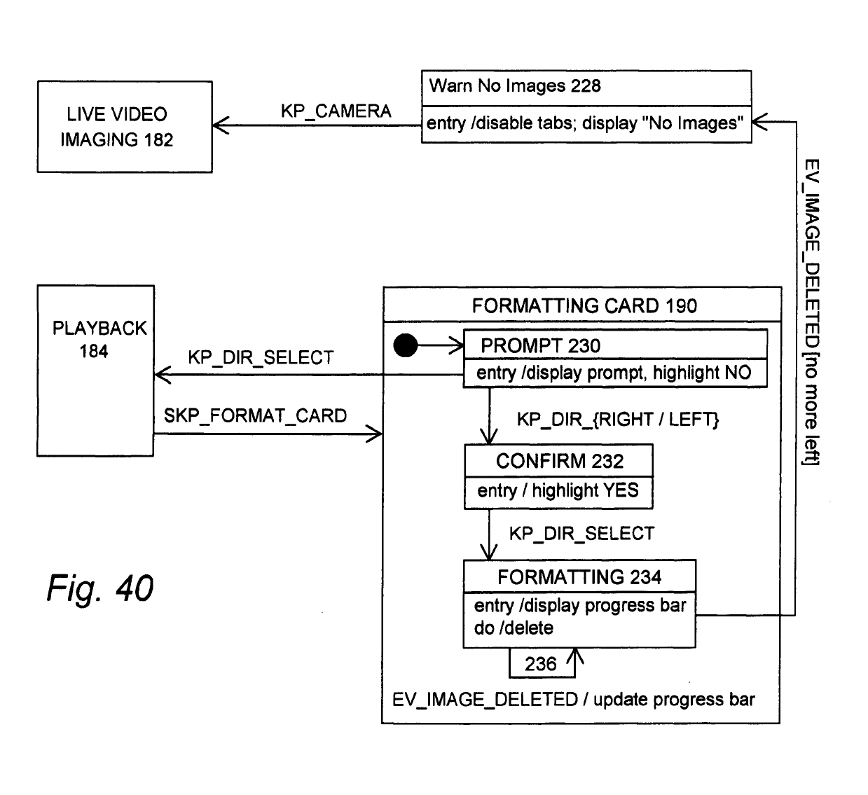

FIG. 40 is a detailed state diagram of one embodiment of the software functions initiated from card formatting function 190.

The following are relevant text notes on the diagram shown in FIGS. 35 through 40.

### Naming

KP_* hardware key press events
SKP_* soft key press events
KR_* hardware key release events
SKR_* soft key release events
EV_* other events

### Soft Keys

Can have more than 4 soft key labels at a time
label1/label2/label3/MORE

### Soft Key Events

Camera.LiveDisplay
   SKP_ROTATE_CCW
   SKP_ROTATE_CW
Camera.CaptureDisplay
   SKP_DELETE (?)
Playback
   SKP_ZOOM
   SKP_ROTATE (CW or CCW?)
   SKP_DELETE
   SKP_GRID_VIEW
   SKP_DELETE_ALL
   SKP_FORMAT_CARD

### Key Events

KP_POWER
KP_SOFT_1
KP_SOFT_2
KP_SOFT_3
KP_SOFT_4
KP_PLAYBACK
KP_CAMERA
KP_DIR_UP
KP_DIR_LEFT
KP_DIR_RIGHT
KP_DIR_DOWN
KP_DIR_SELECT
KP_DISPLAY
KP_SETTINGS
KP_BACK

### Other Events

EV_IMAGE_READY image ready from USB camera
EV_IMAGE_DELETED notification from delete all

### Timeouts

splashTime time for display of initial splash screen while booting
captureDisplayTime time for display of captured image (1 sec).

While the preferred and additional alternative embodiments of the invention have been illustrated and described, it will be appreciated that various changes can be made therein without departing from the spirit and scope of the invention.

1. A camera package, comprising:
a camera;
one or more LED light sources packaged with the camera and directed in a direction of focus of the camera;
means for changing a wavelength of one or more of the light sources;
a video display having a viewing screen;
an interconnecting signal carrying cable coupled between the camera and the display;
a long flexible boom coupled between the camera and the display, the flexible boom being fixable in a selected position; and
a keypad coupled for controlling the camera, the keypad being decoupleable from the camera and coupleable for being addressed by a computer.

2. The camera package of claim 1 wherein the camera further comprises an adjustable lens system, whereby a focus of the camera is adjustable for close distance viewing.

3. The camera package of claim 1 wherein the video display further comprises a handle coupled thereto.

4. The camera package of claim 1 wherein the camera further comprises an adjustable frequency response.

5. The camera package of claim 4 wherein the adjustable frequency response of the camera is further adjustable by means of optical filters to correspond to the wavelength of one or more of the light sources.

6. The camera package of claim 1 wherein an intensity of the one or more of the light sources further comprises an adjustable intensity.

7. The camera package of claim 6 wherein the intensity of the one or more of the light sources is further adjustable by means of a digital potentiometer controlled from the keypad.

8. The camera package of claim 1, further comprising a sound pick-up.

9. The camera package of claim 8 wherein the sound pick-up is further coupled to the boom adjacent to the camera.

10. The camera package of claim 9, further comprising a housing coupled to the boom and housing both the sound pick-up and the camera.

11. The camera package of claim 8, further comprising an audio output device coupled to the sound pick-up remotely therefrom for receiving an audio output signal thereof.

12. The camera package of claim 11, further comprising one or more audio filters coupled for isolating a sound picked up by the sound pick-up.

13. The camera package of claim 12, further comprising means for strobing the one or more light sources at a frequency selected as a function of the sound picked up by the sound pick-up.

14. The camera package of claim 1, further comprising a digital recorder coupled to a video output signal of the camera.

15. The camera package of claim 14, further comprising a sound pick-up and an audio output device coupled thereto for receiving an audio output signal thereof remotely therefrom.

16. The camera package of claim 15 wherein the sound pick-up is further coupled to the boom adjacent to the camera.

17. The camera package of claim 16, further comprising a digital recorder coupled to a video output signal of the camera.

18. The camera package of claim 17 wherein the audio output signal is further coupled to the digital recorder.

19. The camera package of claim 1, further comprising means for rotating a display of the video output signal of the camera on the viewing screen of the video display.

20. The camera package of claim 19 wherein the display rotating means further comprises one or more control pads coupled to one or more electrical circuits structured for rotating the display.
